(19) United States
(12) Patent Application Publication
(10) Pub. No.: US 2026/0267543 A1
(43) Pub. Date: Sep. 10, 2026

(54) DATA SEARCH METHOD AND DEVICE

(71) Applicant: Samsung Electronics Co., Ltd., Suwon-si (KR)

(72) Inventors: Yeyang WANG, Suwon-si (KR); Zhixue ZHAO, Suwon-si (KR)

(73) Assignee: Samsung Electronics Co., Ltd., Suwon-si (KR)

(21) Appl. No.: 19/236,141

(22) Filed: Jun. 12, 2025

(30) Foreign Application Priority Data
Mar. 7, 2025 (CN) 2025 1 0272718.4

(51) Int. Cl. G06F 3/06

(52) U.S. Cl. CPC G06F 3/0638; G06F 3/061; G06F 3/0679

(57) ABSTRACT

A data search method and device are provided according to some example embodiments. The data search method including: obtaining, by a host, a user input vector; determining, by at least one CXL Memory Module DRAM Compute (CMM-DC) device, M objects that are nearest in distance to the user input vector from a dataset stored in the at least one CMM-DC device; and determining, by the host, K first objects that are nearest in the distance to the user input vector from among the M objects.

### CROSS-REFERENCE TO RELATED APPLICATION

This application is based on and claims priority under 35 U.S.C. § 119 to Chinese Patent Application No. 202510272718.4, filed on Mar. 7, 2025, in the China National Intellectual Property Administration, the disclosure of which is incorporated by reference herein in its entirety.

### BACKGROUND

### 1. Field

The present disclosure relate to the data search technical field, and more specifically, to a data search method and device.

### 2. Related Art

The Approximate Nearest Neighbor Search (ANNS) is widely used as a core sub-procedure for search recommendation, machine learning and information retrieval, and as one of infrastructures for ChatGPT and other Large Language Model (LLM) based related applications. With the rapid development of modern AI applications, it has become increasingly important to build efficient ANNS solutions to handle massive datasets.

Currently, many AI systems (e.g., production-level recommender systems) may generate datasets of billion-level. Tens of terabytes of working memory space is required or advantageous for executing ANNS, which significantly increases requirements and pressure on the memory. Due to constraints for memory capacity, ANNS algorithms face a fundamental trade-off between query latency and accuracy. Existing ANNS solutions typically use compressed data or tiered storage (e.g., using Solid State Disks (SSDs)) to extend memory to address this problem.

Most of the current ANNS solutions are based on heterogeneous memory hardware architectures to store and process the datasets of billion-level, but still suffer from the following problems: Almost all computations rely on CPU, which may increase CPU occupancy and lead to relatively high latency. A large amount of data may be moved between CPU and memory, resulting in relatively low Queries Per Second (QPS). Condition filtering may be placed before or after ANNS processing, resulting in moving of a large amount of invalid data, which wastes and/or reduces bandwidth and CPU resources.

### SUMMARY

Some example embodiments of the present disclosure provide a data search method and/or device.

According to some example embodiments, there is provided a data search method including: obtaining, by a host, a user input vector; determining, by at least one CXL Memory Module DRAM Compute (CMM-DC) device, M objects that are nearest in distance to the user input vector from a dataset stored in the at least one CMM-DC device; and determining, by the host, K first objects that are nearest in the distance to the user input vector from among the M objects.

According to some example embodiments, invalid data (e.g., data that does not meet the filtering conditions) may be prevented or mitigated from being sent to the host due to conditional filtering being performed in the CMM-DC devices.

According to some example embodiments, there is provided a data search device including: a host configured to obtain a user input vector; and at least one CXL Memory Module DRAM Compute (CMM-DC) device configured to determine M objects that are nearest in distance to the user input vector from a dataset stored in the at least one CMM-DC device, the host further configured to determine K first objects that are nearest in the distance to the user input vector from among the M objects.

According to some example embodiments, there is provided a non-transitory computer readable storage medium storing a computer program that, when executed by a processor, cause the processor to implement the data search method as described herein according to any of the example embodiments.

According to some example embodiments, there is provided a method of operating a data search device, the data search device including a host and at least one CXL Memory Module DRAM Compute (CMM-DC) device, the method comprising obtaining a user input vector, determining M objects that are nearest in distance to the user input vector from a dataset stored in the at least one CMM-DC device, and determining K first objects that are nearest in the distance to the user input vector from among the M objects.

### BRIEF DESCRIPTION OF DRAWINGS

The above and other purposes and features of the present disclosure will become more apparent through the following descriptions made in conjunction with the FIGURES schematically illustrating the embodiments, in which:

FIG. 1 illustrates a flowchart of an ANNS method according to some example embodiments;

FIG. 2 illustrates an overall architectural diagram of an ANNS method according to some example embodiments;

FIG. 3 illustrates a schematic diagram of a single CMM-DC device performing a Top-K calculation according to some example embodiments;

FIG. 4 illustrates a flowchart of an ANNS method with filtering conditions according to some example embodiments;

FIG. 5 illustrates a flowchart of a process for storing a dataset or a data subset, according to some example embodiments; and

FIG. 6 illustrates a block diagram of structure of a data search device according to some example embodiments.

### DETAILED DESCRIPTION

Some embodiments of the current disclosure may provide an ANNS method and device with improved query accuracy while reducing query latency.

Hereinafter, various example embodiments of the present disclosure are described with reference to the accompanying drawings, in which like reference numerals are used to depict the same or similar elements, features, and structures. However, the present disclosure are not intended to be limited by the various example embodiments described herein and it is intended that the present disclosure cover all modifications, equivalents, and/or alternatives of the present disclosure, provided they come within the scope of the appended claims and their equivalents. The terms and words used in the following description and claims are not limited to their dictionary meanings, but are merely used to enable a clear and consistent understanding of the present disclosure. Accordingly, it should be apparent to those skilled in the art that the following description of various example embodiments of the present disclosure are provided for illustration purpose only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In various example embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various example embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe some example embodiments, but example embodiments are not limited thereto. Unless otherwise indicated herein, all terms used herein, including technical and/or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding some example embodiments of the present disclosure.

As understood by those skilled in the art, ANNS refers to a method for finding points (or objects) that are approximate nearest neighbors of a given query point (or a given input vector) in a large dataset, which may reduce the amount of computation required to search the nearest neighbors in a high-dimension space by a constructed specific data structures (e.g., a spatial division-based KD-Tree, locality-sensitive hashing (LSH), etc.), and/or by using specific algorithmic logics. ANNS is widely used in recommendation systems, image retrieval, pattern recognition, etc.

In order to solve the problem of memory capacity limitation for the ANNS, most of the current ANNS solutions are based on heterogeneous memory hardware architectures for storing and processing datasets.

For example, Microsoft's HM-ANN scheme based on heterogeneous memory (HM) (wherein Optane PMM and DRAM are used to build the heterogeneous memory) stores data hierarchically when building a system. The HM-ANN scheme stores a Navigation Graph in a fast storage device (e.g., a DRAM) and the other data in a relatively slow storage device (e.g., an Optane PMM). The ANNS speed is improved by constructing a high-quality navigation graph such that most accesses during searching occur in DRAM and fewer in PMM, e.g., most searching occurs in fast memory and searching in slow memory is minimized.

However, this scheme still stores a complete dataset in PMM and the navigation graph in the DRAM. There is moving of a lot of data between the CPU and the memory and PMM which consumes a lot of bandwidth. Operations such as distance computing for vectors, candidate updating, and navigation graph updating all rely on the CPU and thus results in high CPU usage.

For another example, DiskANN scheme of Microsoft® proposes a new algorithm called Vamana. This algorithm may accelerate ANNS by generating graph indices with diameters smaller than that of the Navigating Spreading-out Graph (NSG) and the Hierarchical Navigable Small World Graph (HNSW) so that the DiskANN scheme may minimize the number of sequential reads for the disk, and then storing the compressed graph indices in the DRAM and the remaining data in SSDs, and finally prefetching and temporarily storing possible nodes. This scheme may help commodity-grade SSDs to effectively support a large-scale ANNS.

However, this scheme uses a compression manner and a query hit on a compressed index is treated as a hit on data, which negatively affects the precision and recall of results. This scheme stores all data in an SSD having much lower read and write performance than the DRAM, resulting in a higher latency. All computations for this scheme are done by the CPU, resulting in a large amount of compressed and raw data being exchanged among the SSD, the DRAM, and the CPU, which degrades system performance.

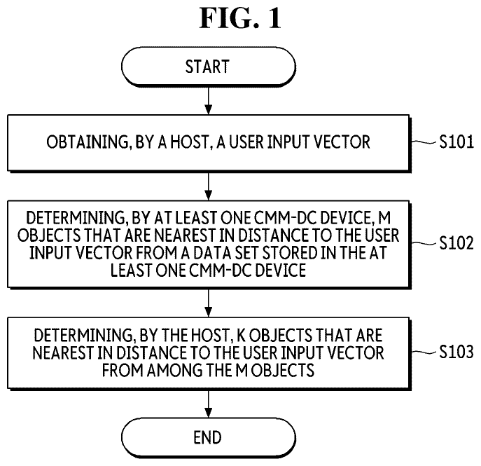

FIG. 1 illustrates a flowchart of a data search method according to some example embodiments.

Referring to FIG. 1, at step S101, a user input vector is obtained by a host.

For ease of description, the host and the user input vectors described herein may also be referred to as a host device and a user query vector, respectively.

As an example, the user input vector may include filtering conditions or may not include filtering conditions.

Those skilled in the art should understand that the operations performed by the host described herein may also be expressed as operations performed by a CPU of the host.

At step S102, M objects that are nearest in distance to the user input vector are determined by at least one CXL Memory Module, D: DRAM, C: Compute (CMM-DC) device from a dataset stored in the at least one CMM-DC device.

Those skilled in the art should understand that the M objects indicate approximate nearest Neighbors found from the dataset stored in the at least one CMM-DC device based on the ANNS.

As understood by those skilled in the art, the CMM-DC device is a Samsung-developed computing memory including a computing unit (or accelerator) and a storage unit (e.g., DRAM bank). Since the CMM-DC device supports the CXL specification, it may improve speed and efficiency of connection between the CMM-DC device and the CPU.

In some example embodiments, the determining M objects that are nearest in distance to the user vector may be performed by adding corresponding logic to the CMM-DC device and/or the accelerator of the CMM-DC device.

In some example embodiments, the CMM-DC device may transmit and/or send the M objects and/or distances between the acquired M objects and the user query vector to the memory of the host.

At step S103, K objects that are nearest in distance to the user input vector are determined by the host from among the M objects.

Those skilled in the art should understand that the K objects indicate approximate nearest Neighbors that are found from among the M objects based on the ANNS.

In some example embodiments, the determining the K objects that are nearest in distance to the user input vector may be performed by adding corresponding logic in the CPU of the host.

In some example embodiments, K is a preset value or is determined based on a user input.

In some example embodiments, K may be included in the user input vector.

In some example embodiments, the host may determine, from among the M objects, the K objects that are nearest in distance to the user input vector based on a distance between each of the M objects and the user query vector.

According to some example embodiments, the ANNS is firstly performed by the CMM-DC device, and then a final ANNS result is determined by the host based on a result of the ANNS of the CMM-DC device so that a portion of computation of the ANNS is offloaded to the CMM-DC device, which may reduce computational pressure on the CPU while reducing the amount of memory accessed by the CPU.

In addition, some example embodiments may reduce query latency because full data is stored in the DRAM bank of the CMM-DC device and the CMM-DC device supports the CXL specification.

In some example embodiments, the dataset includes a plurality of data subsets (or sub-datasets), the number of the at least one CMM-DC device is n, and the determining the K objects that are nearest in distance to the user input vector includes: determining, by each of the at least one CMM-DC device, K objects that are nearest in distance to the user input vector from a data subset corresponding to the each CMM-DC device among the plurality of data subsets; and determining n*K objects, which is determined by the at least one CMM-DC device from data subsets corresponding to the at least one CMM-DC device among the plurality of data subsets, to be the M objects.

As an example, the at least one CMM-DC device may constitute a CMM-DC pool or a pool of CMM-DC devices.

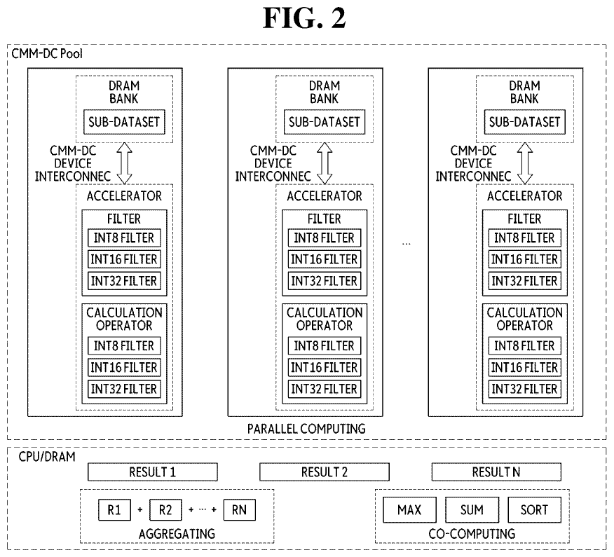

FIG. 2 illustrates an overall architectural diagram of a data search method according to some example embodiments.

Referring to FIG. 2, the ANNS may be performed by each CMM-DC device for a data subset corresponding to each CMM-DC device to obtain an ANNS sub-result, then the ANNS sub-results obtained by respective CMM-DC devices may be aggregated by the host, and a final ANNS result may be determined from the aggregated sub-results by a collaborative calculation.

It should be understood by those skilled in the art that while some example embodiments, such as FIG. 2, illustrate that a filter is included in the each CMM-DC device, example embodiments are not limited thereto. For example, in some example embodiments, each CMM-DC device may not include a filter.

Those skilled in the art should understand that the filter may be a logic unit constructed in an accelerator of the CMM-DC device.

In some example embodiments, the determining, by each of the at least one CMM-DC device, the K objects that are nearest in distance to the user input vector from the data subset corresponding to the each CMM-DC device among the plurality of data subsets includes: filtering objects in the data subset corresponding to the each CMM-DC device based on filtering conditions included in the user input vector to obtain a filtered data subset corresponding to the each CMM-DC device; and determining K objects, which are nearest to the user input vector from the filtered data subset corresponding to the each CMM-DC device, to be the K objects that are nearest in distance to the user input vector determined from the data subset corresponding to the each CMM-DC device

It should be understood by those skilled in the art that while the filtering conditions are described above as being included in the user input vector, this is merely exemplary and does not limit the example embodiments of the present disclosure. For example, the user input vector may not include a filtering condition, and the user input vector and the filtering condition may be included in a user input and/or inputted into the host as different user inputs.

For example, the CMM-DC may filter objects in a data subset corresponding to the each CMM-DC device based on a first user input indicating the filtering condition to obtain a filtered data subset, and then determine, based on a second user input indicating the user input vector, K objects that are near or nearest to the user input vector from the filtered data subset corresponding to the each CMM-DC device.

In some example embodiments, the first user input and the second user input may be included in a single user input.

For example, in order to search for a person corresponding to a certain picture in a database, if the picture and ‘a height being not less than 170 cm’ are used as an input, the picture may be regarded as the user input vector and ‘the height being not less than 170 cm’ may be considered as the filter condition. But example embodiments are not limited to the filter condition being ‘the height being not less than 170 cm’, and in some example embodiments, any form and/or type of filter condition may be used, such as, but not limited to, a width and/or length not being less than or equal to a desired width and/or length, a width and/or length not being greater than a desired width and/or length, a width and/or length not being greater than or equal to a desired width and/or length.

In some example embodiments, a filtering operation may be performed by adding corresponding logic to the CMM-DC device and/or an accelerator of the CMM-DC device.

For example, the filtering operation may be performed based on the filtering condition by a filtering unit in an accelerator of the CMM-DC device. For example, a filtering command may be transmitted and/or sent by the host to each of the CMM-DC devices running in parallel, and the CMM-DC devices may perform filtering objects on their corresponding data subsets based on the filtering command.

In some example embodiments, each CMM-DC device may quantize data in the data subset to INT8, FP16, or FP32 type, and then may perform filtering on the quantized objects.

According to some example embodiments, invalid data (e.g., data that does not meet the filtering condition) may be prevented or mitigated from being transmitted and/or sent to the host due to the conditional filtering performed in the CMM-DC device.

In some example embodiments, distances described herein may indicate a Euclidean distance (or L2 distance (L2-dist)), an inner product (IP) distance (IP-dist), or a cosine distance (C-dist).

The CMM-DC device provides a collection of Basic Linear Algebra Subprograms (BLAS) functions. For example, the collection of functions includes BLAS1 for element-by-element addition/multiplication or layer normalization, and BLAS2 for vector matrix multiplication, and thus the CMM-DC device may perform calculation of distance between the user input vector and an object in the data subset, and perform candidate result updating by using the collection of functions. In some example embodiments, the CMM-DC device may perform parallel processing to accelerate the Top-K computation.

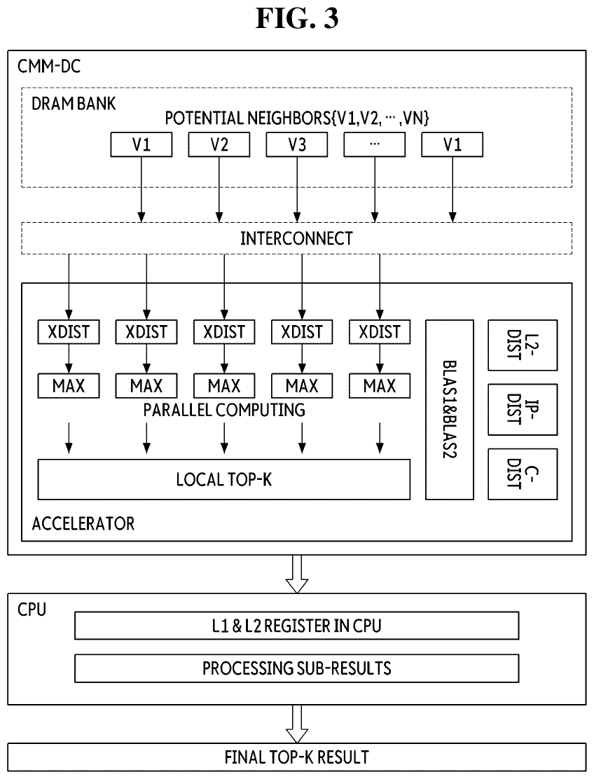

FIG. 3 illustrates a schematic diagram of a single CMM-DC device performing Top-K computation according to some example embodiments.

Referring to FIG. 3, the CMM-DC device moves objects in the data subset to an accelerator. The accelerator may calculate distances between the user input vector and objects in the data subset (e.g., which may be referred to as potential neighbors and/or potential nodes) by using the L2, IP, and COSINE operators, and then may determine the K objects that are near or nearest to the query vector in the potential neighbors or K distances that are shortest from among the calculated distances by using a Max operator.

Referring to FIG. 2 or FIG. 3, after parallel computing within the CMM-DC devices, sub-results of the respective CMM-DC devices are combined, aggregated, and computed in the CPU/DRAM, and then the final ANNS result is derived.

For example, the CMM-DC devices transmits and/or sends the determined local Top-K results to the host, and the host may perform aggregation of the local Top-K results from the at least one CMM-DC device by using an aggregation operator, and then may determine a final Top-K result from the local Top-K results obtained from the at least one CMM-DC device by using a MAX/Sort/SUM operator.

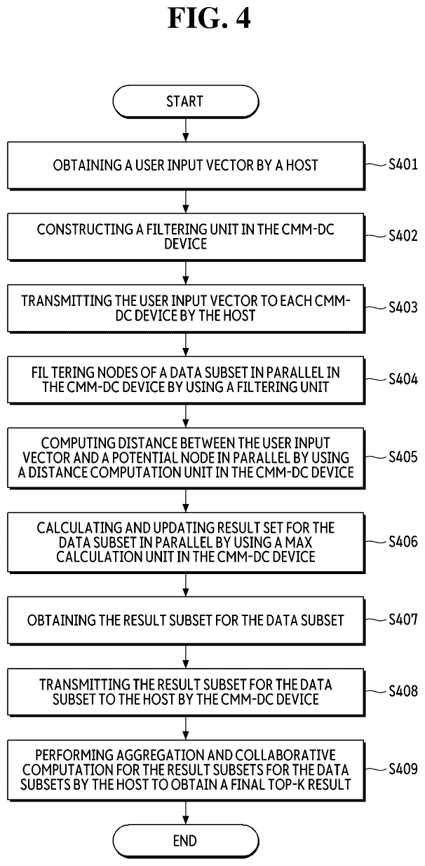

FIG. 4 illustrates a flowchart of a data search method with filtering conditions according to some example embodiments.

Referring to FIG. 4, at step S401, a user input vector is obtained by a host.

At step S402, a filtering unit is constructed in the CMM-DC device.

At step S403, the host transmits and/or sends the user input vector to each CMM-DC device.

At step S404, nodes of a data subset are filtered in parallel in the CMM-DC device by using a filtering unit.

At step S405, a distance between the user input vector and a potential node is computed in parallel by using a distance computation unit in the CMM-DC device.

At step S406, a result set (or a sub result set) for the data subset is calculated and updated in parallel by using a MAX calculation unit in the CMM-DC device.

At step S407, the result subset for the data subset is obtained.

At step S408, the CMM-DC device transmits and/or sends the result subset for the data subset to the host.

At step S409, the host performs aggregation and collaborative computation for the result subsets for the data subsets to obtain a final TOP-K result.

In some example embodiments, steps S402 and S404 in FIG. 4 may be omitted for the ANNS method without filtering conditions.

In some example embodiments, the method illustrated in FIG. 1 may further include: dividing the dataset into the plurality of data subsets by the at least one CMM-DC device.

In some example embodiments, the data subset corresponding to the each CMM-DC devices is stored in the each CMM-DC device.

In some example embodiments, the method illustrated in FIG. 1 may further include: dividing the dataset into the plurality of data subsets by the host.

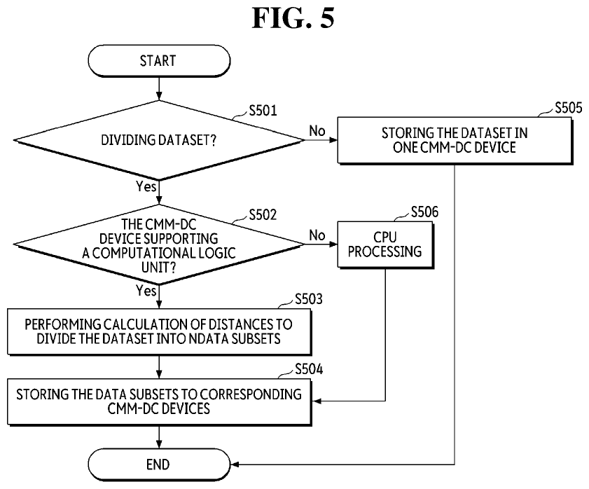

FIG. 5 illustrates a flowchart of a process for storing a dataset or a data subset according to some example embodiments.

Referring to FIG. 5, at step S501, it is determined whether or not a dataset and/or data needs to be, or is advantageous to be, divided into n data subsets, where n is an integer larger than 1. In some example embodiments, at step S501, the host may determine whether or not it would be advantageous to divide a dataset and/or data into n data subsets, where n is an integer larger than 1.

In some example embodiments, it may be determined whether or not a dataset and/or data needs to be, or is advantageous to be, divided into the n data subsets based on the number of CMM-DC devices. In some example embodiments, the host may determine whether or not it would be advantageous to divide the dataset and/or the data into n data subsets based on the number of CMM-DC devices.

In some example embodiments, when it is determined that only one CMM-DC device exists, it may be determined, at step S501, that there is no need or advantage to divide the dataset into the n data subsets. For example, when the host determines that only one CMM-DC device exists, the host may determine, at step S501, that there is no need or advantage in dividing the dataset into the n data subsets. In some example embodiments, when it is determined that n CMM-DC devices exist, it may be determined, at step S501, that there is a need or advantage to divide the dataset into the n data subsets. For example, when the host determines that n CMM-DC devices exist, the host may determine, at step S501, that there is a need or advantage to divide the dataset into the n data subsets.

In some example embodiments, in response to determining that there is no need or advantage in dividing the dataset into the n data subsets, “N” at step S501, the dataset is stored in one CMM-DC device at step S505. For example, in response to determining that there is no need in, or advantage to, dividing the dataset into the n data subsets, “N” at step S501, the host stores the dataset in one CMM-DC device at step S505.

At step S502, it is determined whether the CMM-DC device supports a computational logic unit. For example, in response to determining that there is a need in, or advantage to, dividing the dataset into the n data subsets, “Y” at step S501, the host determines whether the CMM-DC device supports a computational logic unit at step S502.

At step S503, calculation of distances between objects in the dataset is performed using the computational logic unit of the CMM-DC device to divide the dataset into the n data subsets. For example, in response to determining that the CMM-DC device supports a computational logic unit, “Y” at step S502, calculation of distances between objects in the dataset is performed using the computational logic unit of the CMM-DC device at step S503 to divide the dataset into the n data subsets.

In some example embodiments, a clustering method may be used to divide the dataset into the n data subsets.

At step S504, the data subsets are stored into corresponding CMM-DC devices.

According to some example embodiments, each CMM-DC device may store only one data subset.

At step S506, the dataset is divided into the n subsets by a host. For example, in response to determining that the CMM-DC device does not support a computational logic unit, “N” at step S502, the dataset is divided into the n subsets by the host at step S506, and the data subsets are stored into corresponding CMM-DC devices at step S504.

According to some example embodiments of the present disclosure, using a CMM-DC device to store the full data may avoid or mitigate the impact of compressed data on the precision and recall of query results.

In some example embodiments, in a scenario where the amount of data increases, it may be only necessary or advantageous to add another CMM-DC device without any special modification. Accordingly, the ANNS according to some example embodiments of the present disclosure may have good or improved scalability.

In some example embodiments, for simple data filtering and distance calculation, the CMM-DC device is more environmentally friendly than CPU/GPU, and the efficiency of the CMM-DC device is high or much higher than the efficiency of a GPU device such that the energy consumption of the ANNS is reduced.

Table 1 illustrates a comparison of the performance metrics of the ANNS method according to some example embodiments of the present disclosure with those of the ANNS method in the related art.

TABLE 1

| | | | Data |
|---|---|---|---|
| | The number of times | Amount of | loading |
| | CPU accesses memory | moved data | speed |
| Related art | N (the number of | Data amount of | Speed of the |
| | potential nodes) | the potential | device such |
| | | nodes | as PMM, |
| | | | SSD |
| Example | n (degree of parallelism) + | Data amount of | Speed of |
| embodiments | 1 (aggregation calculation) | n*K results | CXL.mem |

Referring to Table 1, n denotes the number of CMM-DC devices in the pool of CMM-DC devices, which is much smaller than N. K denotes the number of results generated by a single CMM-DC device, which depends on the K parameters of the Top-K query, and the data amount of n*K results is much smaller than the data amount of the potential nodes.

According to some example embodiments of the present disclosure, by offloading data-intensive computations (e.g., distance computing, condition filtering) to the CMM-DC device, the occupancy for the CPU of the host and a large number of data interactions between CPU and the memory are reduced, thereby improving the efficiency of the ANNS.

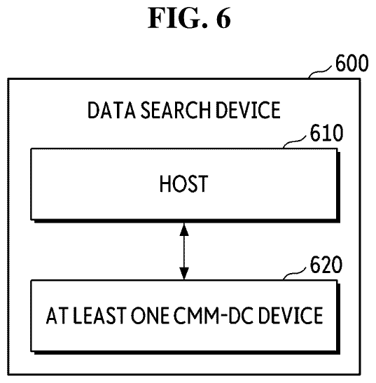

The data search method according to some example embodiments of the present disclosure is described above with reference to FIGS. 1 to 5, and a data search device according to some example embodiments of the present disclosure will be described below with reference to FIG. 6.

FIG. 6 is diagram illustrating a structure of a data search device according some example embodiments.

Referring to FIG. 6, the data search device 600 may include: a host 610 and at least one CMM-DC device 620.

It should be appreciated by those skilled in the art that the data search device 600 according to some example embodiments may additionally include other components, and that at least one of the components included in the data search device 600 may be combined or divided.

In some example embodiments, the host 610 may be configured to obtain a user input vector.

In some example embodiments, the at least one CMM-DC device 620 may be configured to determine M objects that are nearest in distance to the user input vector from a dataset stored in the at least one CMM-DC device.

In some example embodiments, the host 610 may be further configured to determine K objects that are near or nearest in distance to the user input vector from among the M objects.

In some example embodiments, the dataset includes a plurality of data subsets, the number of the at least one CMM-DC device 620 is n, and each of the at least one CMM-DC device is configured to determine, from a data subset corresponding to the each CMM-DC devices among the plurality of data subsets, K objects that are near or nearest in distance to the user input vector, wherein n*K objects, which are determined from data subsets corresponding to the at least one CMM-DC device among the plurality of data subsets by the at least one CMM-DC device, is determined to be the M objects by the at least one CMM-DC device 620.

In some example embodiments, the each CMM-DC device 620 is configured to filter objects in the data subset corresponding to the each CMM-DC device based on filtering conditions included in the user input vector to obtain a filtered data subset corresponding to the each CMM-DC device, and determine K objects, which are near or nearest to the user input vector from the filtered data subset corresponding to the each CMM-DC device, to be the K objects that are near or nearest in distance to the user input vector determined from the data subset corresponding to the each CMM-DC device.

In some example embodiments, the distance indicates a Euclidean distance, an inner product distance, or a cosine distance.

In some example embodiments, the at least one CMM-DC device 620 may be further configured to divide the dataset into the plurality of data subsets.

In some example embodiments, the data subset corresponding to the each CMM-DC device is stored in the each CMM-DC device.

In some example embodiments, the host 610 may be further configured to divide the dataset into the plurality of data subsets.

According to some example embodiments of the present disclosure, there is provided a computer readable storage medium storing a computer program that when executed by a processor causes the processor to implement the data search method as described herein according to some example embodiments. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In some example embodiments, the computer program and any associated data, data files and data structures are distributed on networked computer systems, so that computer programs and any associated data, data files, and data structures are stored, accessed, and executed in a distributed manner through one or more processors or computers.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

According to some example embodiments of the present disclosure, there may be provided a computer program product, wherein instructions in the computer program product may be executed by a processor of a computer device to implement the data search method described herein.

Those skilled in the art will easily think of other example embodiments of the present disclosure after considering the specification and practicing the disclosure disclosed herein. The present disclosure are intended to cover any variations, uses, or adaptive changes of some example embodiments of the present disclosure. These variations, uses, or adaptive changes follow the general principles of the present disclosure. The specification and the example embodiments described herein are to be regarded as exemplary only, and the actual scope and spirit of the present disclosure are pointed out by the following claims.

What is claimed is:

1. A data search method, the method comprising:
obtaining, by a host, a user input vector;
determining, by at least one CXL Memory Module DRAM Compute (CMM-DC) device, M objects that are nearest in distance to the user input vector from a dataset stored in the at least one CMM-DC device; and
determining, by the host, K first objects that are nearest in the distance to the user input vector from among the M objects.

2. The method of claim 1, wherein
the dataset comprises a plurality of data subsets,
a number of the at least one CMM-DC device is n, and
the determining the K first objects that are the nearest in the distance to the user input vector comprises,
determining, by each of the at least one CMM-DC device, K second objects that are nearest in the distance to the user input vector from a data subset corresponding to the each of the at least one CMM-DC device among the plurality of data subsets; and
determining n*K of the K second objects as the M objects, the K second objects determined by the at least one CMM-DC device from data subsets of the plurality of data subsets corresponding to the at least one CMM-DC device.

3. The method of claim 2, wherein the determining, by each of the at least one CMM-DC device, the K second objects that are nearest in the distance to the user input vector from the data subset corresponding to the each of the at least one CMM-DC device among the plurality of data subsets comprises:
filtering objects in the data subset corresponding to the each of the at least one CMM-DC device based on filtering conditions included in the user input vector to obtain a filtered data subset corresponding to the each of the at least one CMM-DC device; and
determining K third objects that are nearest to the user input vector from the filtered data subset corresponding to the each of the at least one CMM-DC device, to be the K second objects that are nearest in the distance to the user input vector determined from the data subset corresponding to the each of the at least one CMM-DC device.

4. The method of claim 1, wherein the distance indicates a Euclidean distance, an inner product distance, or a cosine distance.

5. The method of claim 2, further comprising:
dividing the dataset into the plurality of data subsets by the at least one CMM-DC device.

6. The method of claim 2, wherein the data subset corresponding to the each of the at least one CMM-DC device is stored in the each of the at least one CMM-DC device.

7. The method of claim 2, further comprising:
dividing the dataset into the plurality of data subsets by the host.

8. A data search device, comprising:
a host configured to obtain a user input vector; and
at least one CXL Memory Module DRAM Compute (CMM-DC) device configured to determine M objects that are nearest in distance to the user input vector from a dataset stored in the at least one CMM-DC device,
the host further configured to determine K first objects that are nearest in the distance to the user input vector from among the M objects.

9. The data search device of claim 8, wherein
the dataset comprises a plurality of data subsets,
a number of the at least one CMM-DC device is n,
each of the at least one CMM-DC device is configured to determine, from a data subset corresponding to the each of the at least one CMM-DC device among the plurality of data subsets, K second objects that are nearest in the distance to the user input vector, and
the host is configured to determine n*K of the K second objects as the M objects, the K second objects determined from data subsets of the plurality of data subsets corresponding to the at least one CMM-DC device.

10. The data search device of claim 9, wherein the each of the at least one CMM-DC device is configured to:
filter objects in the data subset corresponding to the each of the at least one CMM-DC device based on filtering conditions included in the user input vector to obtain a filtered data subset corresponding to the each of the at least one CMM-DC device; and
determine K third objects that are nearest to the user input vector from the filtered data subset corresponding to the each of the at least one CMM-DC device, to be the K second objects that are nearest in the distance to the user input vector determined from the data subset corresponding to the each of the at least one CMM-DC device.

11. The data search device of claim 8, wherein the distance indicates a Euclidean distance, an inner product distance, or a cosine distance.

12. The data search device of claim 9, wherein the at least one CMM-DC device is further configured to divide the dataset into the plurality of data subsets.

13. The data search device of claim 9, wherein the data subset corresponding to the each of the at least one CMM-DC device is stored in the each of the at least one CMM-DC device.

14. The data search device of claim 9, wherein the host is further configured to divide the dataset into the plurality of data subsets.

15. A non-transitory computer readable storage medium storing a computer program that, when executed by a processor, cause the processor to implement the data search method of claim 1.

16. A method of operating a data search device, the data search device including a host and at least one CXL Memory Module DRAM Compute (CMM-DC) device, the method comprising:
obtaining a user input vector;
determining M objects that are nearest in distance to the user input vector from a dataset stored in the at least one CMM-DC device; and
determining K first objects that are nearest in the distance to the user input vector from among the M objects.

17. The method of claim 16, wherein
the dataset comprises a plurality of data subsets,
a number of the at least one CMM-DC device is n, and
the determining the K first objects that are the nearest in the distance to the user input vector comprises,
determining, by each of the at least one CMM-DC device, K second objects that are nearest in the distance to the user input vector from a data subset corresponding to the each of the at least one CMM-DC device among the plurality of data subsets; and
determining n*K of the K second objects as the M objects, the K second objects determined by the at least one CMM-DC device from data subsets of the plurality of data subsets corresponding to the at least one CMM-DC device.

18. The method of claim 17, wherein the determining, by each of the at least one CMM-DC device, the K second objects that are nearest in the distance to the user input vector from the data subset corresponding to the each of the at least one CMM-DC device among the plurality of data subsets comprises:
filtering objects in the data subset corresponding to the each of the at least one CMM-DC device based on filtering conditions included in the user input vector to obtain a filtered data subset corresponding to the each of the at least one CMM-DC device; and
determining K third objects that are nearest to the user input vector from the filtered data subset corresponding to the each of the at least one CMM-DC device, to be the K second objects that are nearest in the distance to the user input vector determined from the data subset corresponding to the each of the at least one CMM-DC device.

19. The method of claim 16, wherein the distance indicates a Euclidean distance, an inner product distance, or a cosine distance.

20. The method of claim 17, further comprising:
dividing the dataset into the plurality of data subsets by the at least one CMM-DC device.
